(19) United States
(12) Patent Application Publication
(10) Pub. No.: US 2019/0205882 A1
(43) Pub. Date: Jul. 4, 2019

(54) SYSTEM AND METHODS FOR UPDATING A CARD-NOT-PRESENT ACCOUNT-ON-FILE TRANSACTION BLOCKING SERVICE

(71) Applicant: Mastercard International Incorporated, Purchase, NY (US)

(72) Inventors: Sharon Amy Rosano, New Canaan, CT (US); Kyle Williams, Wentzville, MO (US); David J. Senci, Troy, IL (US)

(73) Assignee: Mastercard International Incorporated, Purchase, NY (US)

(21) Appl. No.: 15/862,149

(22) Filed: Jan. 4, 2018

(51) Int. Cl. G06Q 20/40; G06Q 20/22; G06Q 20/10; G06Q 20/38; G06Q 20/42

(52) U.S. Cl. CPC G06Q 20/407; G06Q 20/22; G06Q 20/42; G06Q 20/389; G06Q 20/102

(57) ABSTRACT

A transaction blocking system for updating a database for a card-not-present account-on-file transaction blocking service includes a memory device for storing data and a processor communicatively coupled to the memory device. The processor is programmed to receive from an issuer a chargeback message including issuer identification information, a chargeback reason code, and a primary account number relating to a payment account of a cardholder. The processor is also programmed to read the chargeback reason code, and determine whether the chargeback message corresponds to a cancelled recurring payment. Furthermore, the processor is programmed to generate an entry within the database in response to determining that the chargeback message corresponds to a cancelled recurring payment. A computer-implemented method for the blocking service is also disclosed.

### FIELD OF THE DISCLOSURE

The field of the disclosure relates generally to systems and methods for updating a transaction blocking service and, more particularly, to systems and methods for an automated process to update a card-not-present account-on-file transaction blocking service when a chargeback is sent from an issuer.

### BACKGROUND OF THE DISCLOSURE

Card-not-present transactions, such as online payment and/or recurring payments are common in the marketplace. In an online payment scenario, a cardholder preauthorizes a merchant to automatically bill a payment card for a purchase. In some cases, the merchant may store the cardholder's payment card information for future transactions. In addition, in a recurring payment scenario, a cardholder preauthorizes a merchant to automatically bill a payment card at a preset interval. Recurring payments are typically done for a matter of convenience for both the cardholder and the merchant. Online and recurring payment transactions typically occur without incident.

A cardholder may cancel a recurring payment and/or request that the merchant remove the cardholder's stored payment card information so future transactions are not processed against the cardholder's account. At least some known payment networks provide a transaction blocking service that automatically declines future transactions for cardholders if the cardholder selects to avoid a specific payment transaction from a certain merchant. For example, if the cardholder is being charged monthly payments for a gym membership that the cardholder cancelled, but the gym has failed or is unwilling to cancel such payments. The cardholder can reach out to the card issuer and request that the issuer manually add the gym to the transaction blocking service to ensure that the gym can no longer charge the cardholder's account.

However, cardholders may not be aware of the transaction blocking service, and when the unwanted transaction is processed against the cardholder's account, the cardholder may ask their issuing bank to send a chargeback to the merchant stating they want to cancel the transaction. The Issuer will then submit a chargeback, often including a reason for the chargeback, but there is nothing preventing the merchant from processing a future transaction against the same cardholder amount.

### BRIEF DESCRIPTION OF THE DISCLOSURE

This summary is not intended to identify essential features of the present invention, and is not intended to be used to limit the scope of the claims. These and other aspects of the present invention are described below in greater detail.

In one aspect, a transaction blocking system is provided. The transaction blocking system is configured for updating a database for a card-not-present account-on-file transaction blocking service. The transaction blocking system includes a memory device for storing data, and a processor communicatively coupled to said memory device. The processor is programmed to receive from an issuer a chargeback message including issuer identification information, a chargeback reason code, and a primary account number relating to a payment account of a cardholder. In addition, the processor is programmed to read the chargeback reason code, and determine whether the chargeback message corresponds to a cancelled recurring payment. Moreover, the processor is programmed to generate an entry within the database in response to determining that the chargeback message corresponds to a cancelled recurring payment.

In another aspect, a computer-implemented method for updating a database for a card-not-present account-on-file transaction blocking service is provided. The method includes receiving, from an issuer, a chargeback message including issuer identification information, a chargeback reason code, and a primary account number relating to a payment account of a cardholder. The method also includes determining whether the chargeback message corresponds to a cancelled recurring payment. In response to determining that the chargeback message corresponds to a cancelled recurring payment, the method includes extracting copies of the primary account number and the issuer identification information from the chargeback message. Moreover, the method includes storing the extracted primary account number and issuer identification information in the memory device, and generating an entry within the database.

In yet another aspect, one or more non-transitory computer-readable storage media having computer-executable instructions embodied thereon is provided. When executed by at least one processor, the computer-executable instructions cause the processor to receive from an issuer a chargeback message including issuer identification information, a chargeback reason code, and a primary account number relating to a payment account of a cardholder. In addition, the executable instructions cause the processor to read the chargeback reason code and determine whether the chargeback message corresponds to a cancelled recurring payment. In response to determining that the chargeback message corresponds to a cancelled recurring payment, the executable instructions cause the processor to extract copies of the primary account number and the issuer identification information from the chargeback message, and store the extracted primary account number and issuer identification information in a memory device. Moreover, the executable instructions cause the processor to generate an entry within a database for a card-not-present account-on-file transaction blocking service.

### BRIEF DESCRIPTION OF THE DRAWINGS

Embodiments of the present invention are described in detail below with reference to the attached drawing figures, wherein:

FIG. 1 is a block diagram of an example multi-party payment card network system having a card-not-present blocking service (CNPBS) update module;

FIG. 2 is a simplified block diagram of an example payment network including a transaction processing system (TPS) for updating a CNPBS database using the CNPBS update module shown in FIG. 1;

FIG. 3 is an example configuration of a server system, such as a server system for use in the TPS system shown in FIG. 2;

FIG. 4 is a schematic diagram of the payment card network system shown in FIG. 1 showing data flow among the parties during a chargeback transaction; and

FIG. 5 is a flow chart of an example method for updating the CNPBS database shown in FIG. 2.

The figures are not intended to limit the present invention to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to identifying and verifying entities requesting access to confidential information and/or financial services. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly characterized, the present invention relates to systems and methods for updating a card-not-present account-on-file transaction blocking service (CNPBS) database to block or prevent future transactions. More particularly, the disclosed embodiments provide a system and computer-implemented method for automating a process to identify a chargeback where the chargeback reason code indicates the chargeback is because of a “cancelled recurring payment.” In one example embodiment, a CNPBS update system or module is configured for use with a payment card processing network such as, for example, an interchange network. The CNPBS update module includes a memory device and a processor in communication with the memory device and is programmed to communicate with the interchange network to receive a chargeback message from issuers. The CNPBS update module extracts the primary account number (PAN) and issuer identification information from the chargeback message and checks it against the CNPBS database to verify enrollment in the service. If the issuer is enrolled for the associated PAN, the CNPBS update module generates a new entry or listing in the CNPBS database to facilitate preventing or blocking future transactions against the PAN by a specified merchant.

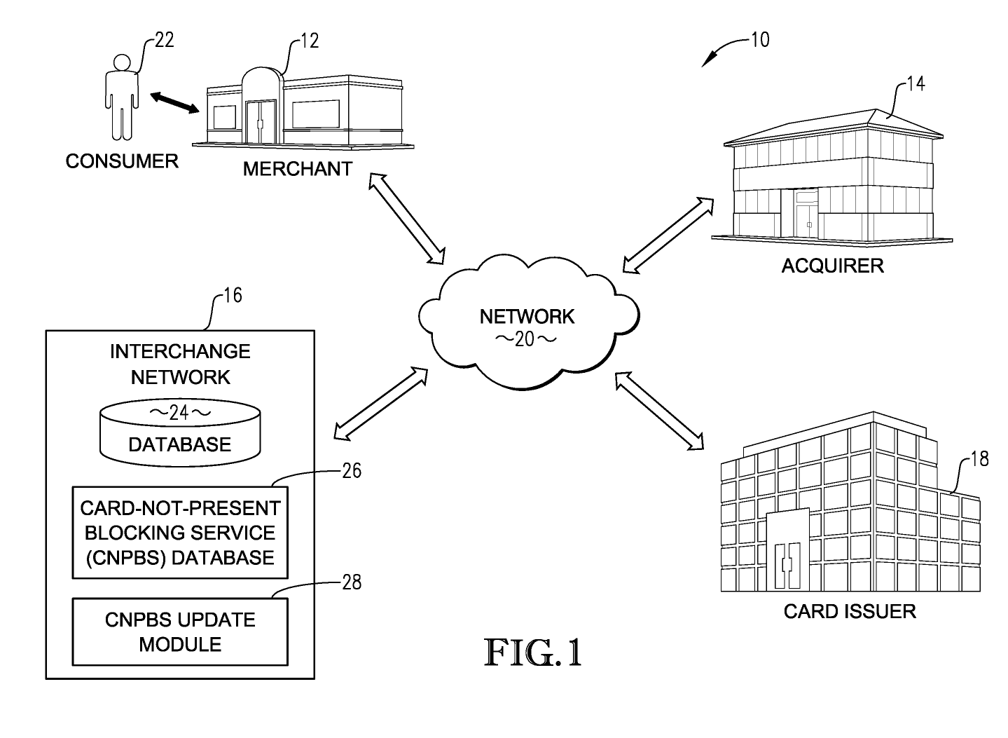

FIG. 1 is a block diagram of an example multi-party payment card network system 10 having a card-not-present blocking service (CNPBS) update module 28 (broadly, a CNPBS update system). The payment card network system 10 facilitates providing interchange network services, such as card-not-present account-on-file (CNP) transaction blocking services, offered by an interchange network 16. In addition, the payment card network system 10 enables payment card transactions in which merchants 12, acquirers 14, and/or card issuers 18 do not need to have a one-to-one relationship.

In the example embodiment, the payment card network system 10 generally includes the merchants 12, the acquirers 14, the interchange network 16, and the issuers 18, coupled in communication via a communications network 20. The communications network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the communications network 20 may include more than one type of network, such as a private payment transaction network provided by the interchange network 16 to the acquirers 14 and the issuers 18 and, separately, the public Internet, which may facilitate communication between the merchants 12, the interchange network 16, the acquirers 14, and the consumers 22, etc.

Embodiments described herein may relate to a transaction card system, such as a credit card payment system using the Mastercard® interchange network. (Mastercard is a registered trademark of Mastercard International Incorporated). The Mastercard interchange network is a set of proprietary communications standards promulgated by Mastercard International Incorporated for the exchange of financial transaction data and the settlement of funds between financial institutions that are members of Mastercard International Incorporated. As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of multi-party payment card network system 10.

In a typical transaction card system, a financial institution called the “issuer” issues a transaction card, such as a credit card, to a cardholder or consumer 22, who uses the transaction card or transaction card account number to tender payment for a purchase from the merchant 12. In the example embodiment, the merchant 12 is typically associated with products, for example, and without limitation, goods and/or services, that are offered for sale and are sold to the consumers 22. The merchant 12 includes, for example, a physical location and/or a virtual location. A physical location includes, for example, a brick-and-mortar store, etc., and a virtual location includes, for example, an Internet-based store-front.

To accept payment with the transaction card, the merchant 12 must normally establish an account with a financial institution that is part of the payment card network system 10. This financial institution is usually called the “merchant bank,” the “acquiring bank,” or the acquirer 14. When the cardholder 22 offers payment for a purchase with a transaction card, the merchant 12 requests authorization from the acquirer 14 for the amount of the purchase. The request may be performed over the telephone, but is usually performed through the use of a point-of-sale terminal that reads the cardholder's account information from a magnetic stripe, a chip, or embossed characters on the transaction card and communicates electronically with the transaction processing computers of the acquirer 14. Alternatively, the acquirer 14 may authorize a third party to perform transaction processing on its behalf. In this case, the point-of-sale terminal will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase is covered by the cardholder's available credit line. Based on these determinations, the request for authorization will be declined or accepted. If the request is accepted, an authorization code is issued to the merchant 12.

When a request for authorization is accepted, the available credit line of the cardholder's account is decreased. Normally, a charge for a payment card transaction is not posted immediately to the cardholder's account because bankcard associations, such as Mastercard International Incorporated, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the cardholder 22 cancels a transaction before it is captured, a “void” is generated. If the cardholder 22 returns goods after the transaction has been captured, a “credit” is generated. In some instances, if the cardholder 22 did not authorize the transaction, such as a previously cancelled recurring payment or a card-not-present account-on-file transaction, a “chargeback” is generated. The interchange network 16 and/or the issuer 18 stores the transaction card information, such as, and without limitation, a type of merchant, a merchant identifier, a location where the transaction was completed, an amount of purchase, and a date and time of the transaction, in a transaction database 24.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12.

In some embodiments, the payment card transaction is a card-not-present account-on-file transaction in which a payment card is not presented to the merchant 12 during a transaction. In such transactions, for example, the merchant 12 may have stored the cardholder's payment card account information from a previous transaction, or may have stored the information based on an agreement for initiating recurring transactions. The interchange network 16 includes the CNPBS update module 28 that is configured to analyze various data associated with the CNP transaction and provide various information to one or more parties involved in the CNP transaction, such as the issuer 18, the merchant 12, and/or the acquirer 14. The CNPBS update module 28 is a specially programmed computer system that enables the interchange network 16 to implement an automated process to update a CNPBS database 26 based on information contained in a chargeback message received from the card issuer 18. The CNPBS update module 28 is specially programmed with a plurality of algorithms that are configured to identify a chargeback reason code from the chargeback message and determine if the primary account number (PAN) and the issuer 18 are enrolled in the CNP transaction blocking service described above. If the PAN and issuer 18 are enrolled in the CNP transaction blocking service, the algorithms that are further configured to update the CNPBS database 26 with transaction identifying information to facilitate blocking future authorization and/or clearing attempts on the PAN from the merchant.

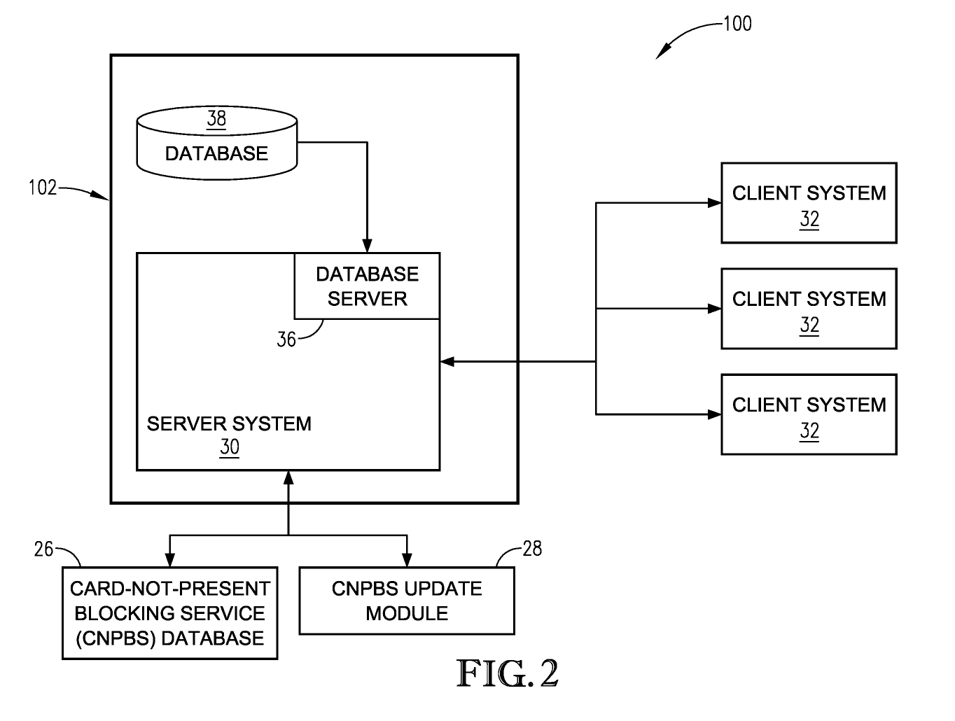

FIG. 2 is a simplified block diagram of an example payment network 100 including a transaction processing system (TPS) 102 for updating the CNPBS database 26 using the CNPBS update module 28. In some embodiments, the payment network 100 is similar to the payment card network system 10 (shown in FIG. 1). In the example embodiment, the payment network 100 includes a plurality of computing devices connected in accordance with the present disclosure. The payment network 100 includes a server system 30 of the TPS 102 in communication with a plurality of client systems 32 associated with merchants 12 (shown in FIG. 1), acquirers 14 (shown in FIG. 1), payment networks, and/or issuers 18 (shown in FIG. 1).

More specifically, in the example embodiment, the TPS 102 includes the server system 30 of, for example, the interchange network 16 (shown in FIG. 1), in communication with the client systems 32 associated with merchants 12, acquirers 14, payment networks, and/or issuers 18. The server system 30 may also in communication with a plurality of client sub-systems, also referred to as client systems 32 herein. In one embodiment, the client systems 32 are computers including a web browser, such that server system 30 is accessible to the client systems 32 using the Internet. The client systems 32 are interconnected to the Internet through one or more of many interfaces including, for example, a network, such as a LAN or WAN, dial-in-connections, cable modems, and/or special high-speed Integrated Services Digital Network (ISDN) lines. The client systems 32 could be any device capable of interconnecting to the Internet including an Internet connected phone, a PDA, or any other suitable web-based connectable equipment.

A database server 36 is connected to a database 38, which is configured to store information on a variety of matters, including transaction data as described herein in greater detail. In one embodiment, the database 38 is a centralized database stored on the server system 30 and can be accessed by potential users at one of the client systems 32 by logging onto the server system 30 through one of the client systems 32. In an alternative embodiment, the database 38 is stored remotely from the server system 30 and may be a distributed or non-centralized database.

In one example embodiment, the database 38 may include a single database having separated sections or partitions or may include multiple databases, each being separate from each other. The database 38 may store transaction data generated as part of sales activities conducted over the processing network including data relating to merchants 12, account holders or customers 22 (shown in FIG. 1), issuers 18, acquirers 14, and/or purchases made. The database 38 may also store account data including at least one of a cardholder name, a cardholder address, the primary account number (PAN), and other account identifier. The database 38 may also store merchant data including a merchant identifier that identifies each merchant registered to use the network, and instructions for settling transactions including merchant bank account information. The database 38 may also store purchase data associated with items being purchased by a cardholder from a merchant, and authorization request data. The database 38 may also store digital wallet data, device information, payment card information, and other data used to identify and facilitate blocking future transactions attempting to be processed by one or more parties to the transaction.

In the example embodiment, one of the client systems 32 may be associated with the merchant 12 and/or the acquirer 14 while another one of the client systems 32 may be associated with the issuer 18. Another client system 32 may be a computer system and/or mobile system used by a cardholder 22 making an on-line purchase or payment. The server system 30 may be associated with the interchange network 16 or a payment processor. In the example embodiment, the server system 30 is associated with a financial transaction processing network, such as the interchange network 16, and may be referred to as an interchange computer system. The server system 30 may be used for processing transaction data. In addition, the client systems 32 may include a computer system associated with at least one of a merchant 12, an online bank, a bill payment outsourcer, an acquirer bank 14, an acquirer processor, an issuer bank 18 associated with a transaction card, an issuer processor, a remote payment processing system, and/or a biller.

In the example embodiment, the TPS 102 is in communication with the CNPBS update module 28 and the CNPBS database 26, which may be associated with the interchange network 16 or with an outside third party in a contractual relationship with the interchange network 16. In some embodiments, the CNPBS update module 28 and the CNPBS database 26 are in communication with each other and may directly interact during the processing of chargeback transactions. In the example embodiment, the CNPBS update module 28 extracts issuer information, the PAN, and the chargeback reason code from the chargeback message (i.e., the chargeback transaction). The CNPBS database 26 provides information corresponding to cancelled recurring payments, merchants prohibited from processing transactions with selected PANs, and other prohibited payment transactions. In some embodiments, the CNPBS update module 28 and/or the CNPBS database 26 are also in communication with an issuer system (e.g., the client systems 32). It is noted that the payment network 100 may include more, fewer, or alternative components and/or perform more, fewer, or alternative actions, including those discussed elsewhere herein.

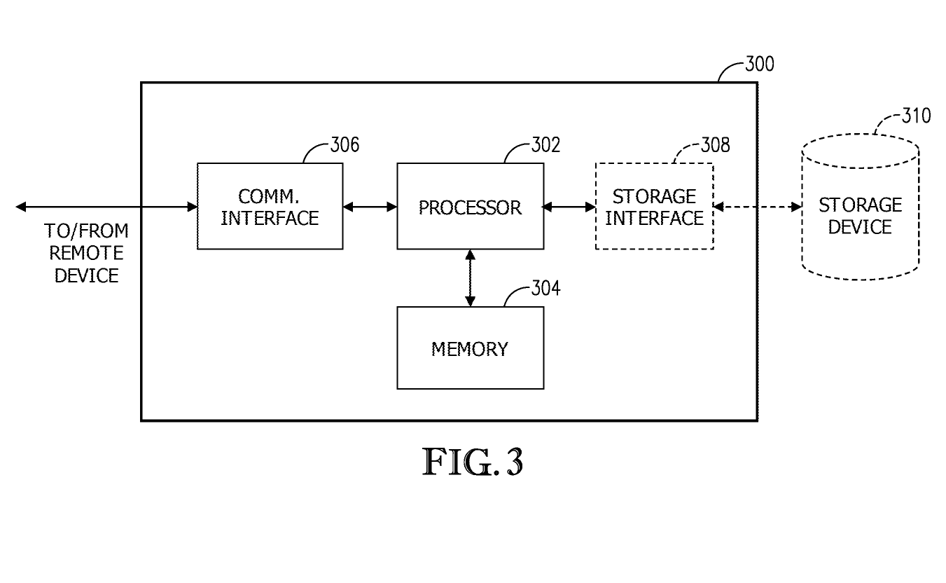

FIG. 3 is an example configuration of a server system 300, such as the server system 30 (shown in FIG. 2). The server system 300 includes, but is not limited to, the transaction database 24 (shown in FIG. 1), the CNPBS update module 28, and/or the CNPBS database 26. In the example embodiment, the server system 300 includes a processor 302 for executing instructions. The instructions may be stored in a memory area 304, for example. The processor 302 includes one or more processing units (e.g., in a multi-core configuration) for executing the instructions. The instructions may be executed within a variety of different operating systems on the server system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 302 is operatively coupled to a communication interface 306 such that the server system 300 can communicate with a remote device such as a client system 32 (shown in FIG. 2) or another server system 300. For example, the communication interface 306 may receive communications from a client system 32 via the Internet, as illustrated in FIG. 2.

The processor 302 is operatively coupled to the storage device 310. The storage device 310 is any computer-operated hardware suitable for storing and/or retrieving data. In some embodiments, the storage device 310 is integrated in the server system 300. In other embodiments, the storage device 310 is external to the server system 300 and is similar to the transaction database 24. For example, the server system 300 may include one or more hard disk drives as the storage device 310. In other embodiments, the storage device 310 is external to the server system 300 and may be accessed by a plurality of server systems 300. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 is operatively coupled to the storage device 310 via a storage interface 308. The storage interface 308 is any component capable of providing the processor 302 with access to the storage device 310. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 310.

The memory area 304 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

In the example embodiment, server system 300 is a card-not-present account-on-file processing system in communication with one or more of the issuer 18 and the merchant 12 during a chargeback transaction involving a challenged transaction of a user, such as cardholder 22 (shown in FIG. 1). The server system 300 performs checking for account information or prohibited transactions in the CNPBS database 26 (shown in FIG. 2) and provides updated account information to the CNPBS database 26 based on the chargeback transaction.

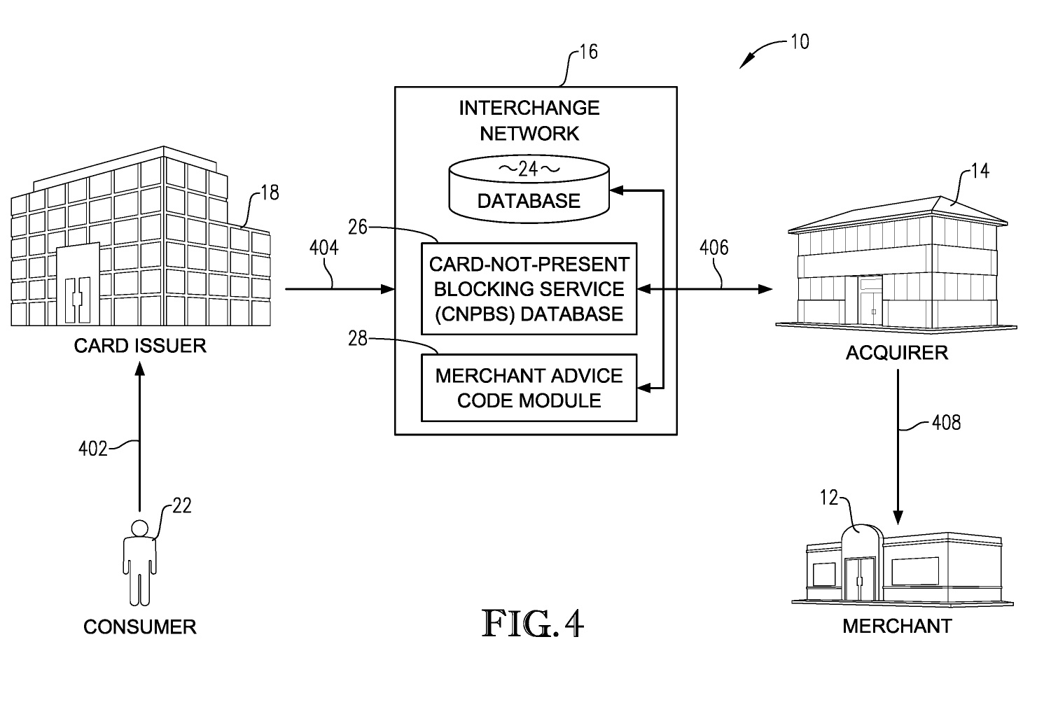

FIG. 4 is a schematic diagram of the payment card network system 10 showing data flow among the parties during a chargeback transaction. In the example embodiment, the chargeback transaction corresponds to a card-not-present account-on-file (CNP) transaction where the merchant 12 was not presented with a payment card by the cardholder 22. Example CNP transactions may include, for example, recurring payments and/or account-on-file transactions that may not have been approved by the cardholder 2.

In the example embodiment, the cardholder 22 may dispute a CNP transaction 402 corresponding, for example, to a previously cancelled recurring payment, an account-on-file transaction, and the like for a product and/or service offered by the merchant 12. For example, and without limitation, the cardholder 22 may file a complaint with the card issuer 18 that issued the cardholder 22 a payment card associated with the chargeback transaction. After receiving the cardholder's complaint, the card issuer 18 may initiate a chargeback transaction on behalf of the cardholder 22. As indicated by arrows 404 and 406, the card issuer 18 may generate and transmit a chargeback message to the acquirer 14 via the interchange network 16. The acquirer 14 may transmit the chargeback message to the merchant, as indicated generally at 408, for processing as business as usual.

As used herein, a “chargeback message” may refer to a data message, or sequence of data messages, used to return funds to the cardholder 22, the funds being associated with one or more transactions (e.g., card-not-present account-on-file transactions). For example, a chargeback can be initiated by the issuer 18 of the account, and may involve a reversal of a prior outbound transfer of funds from the account (e.g., a bank account, line of credit, credit card, debit card, prepaid card, etc.). The chargeback message can include one or more codes identifying the reasons for the chargeback. For example, and without limitation, the chargeback message may include a reason code corresponding to “Cancelled Recurring Payment,” “No Cardholder Authorization,” “Cardholder Dispute,” and the like. In the example embodiment, the CNPBS update module 28 is triggered by the update code corresponding to “Cancelled Recurring Payment.”

It is noted that the chargeback message within an interchange network, such the interchange network 16, may, in at least some instances, conform to the International Organization for Standardization (ISO) Standard 8583, Financial transaction card originated messages-Interchange message specifications, which is the ISO standard for systems that exchange electronic transactions made by cardholders using payment cards. In the example embodiment, the chargeback message can be an ISO 8583 message type identifier (MTI) “0402” message.

As described herein, the issuer 18 communicates with and transmits the MTI 0402 chargeback message to the interchange network 16, as indicated by arrow 404. The interchange network 16, and in particular, the CNPBS update module 28, may extract copies of the issuer information, the PAN, and the chargeback reason code from the MTI “0402” chargeback message. The interchange network 16 validates whether the issuer 18 and the PAN are currently enrolled in the card-not-present account-on-file transaction blocking service. If the issuer 18 is not enrolled, no further action is taken and the chargeback transaction continues as business as usual. If the issuer 18 is enrolled in the service and the chargeback reason code corresponds to “Cancelled Recurring Payment,” the interchange network 16 may extract additional data from the MTI “0402” chargeback message to facilitate generating a new entry in the CNPBS database 26. For example, and without limitation, the interchange network 16 may extract copies of the PAN, the acquirer's interbank card association (ICA) number, the merchant ID, and the transaction amount. This extracted data is used to generate the new listing or entry in the CNPBS database 26. This new entry can be used to flag a future unauthorized transaction, whether recurring or a one-time transaction (e.g., an account-on-file transaction).

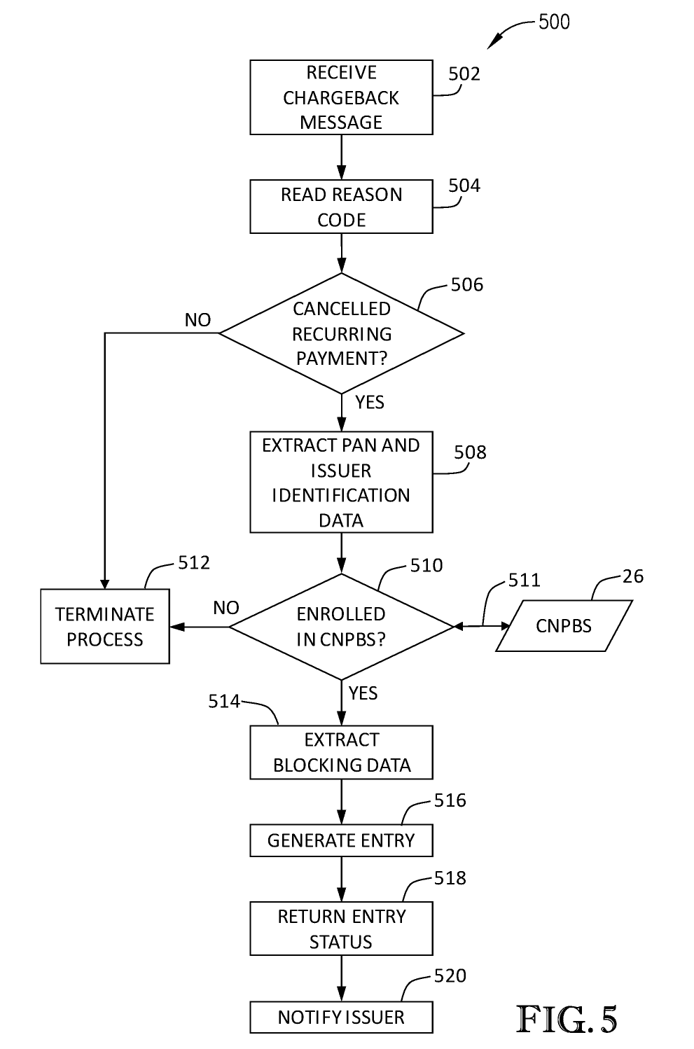

FIG. 5 shows a flow chart of an example method 500 for updating a card-not-present account-on-file transaction blocking service database, such as the CNPBS database 26 (shown in FIG. 1). In the example embodiment, the method 500 is implemented by the CNPBS update module 28 (shown in FIG. 1). The method 500 is a computer-implemented method for extracting transaction data from a chargeback message and generating an entry in the CNPBS database 26 to facilitate blocking future transactions that meet the entry's criteria.

In the example method 500, an operation 502 includes receiving a chargeback message, such as the MTI “0402” chargeback message described herein (shown in FIG. 4). The MTI “0402” chargeback message is submitted by the issuer 18 (shown in FIG. 4) to the merchant bank or acquirer 14 (shown in FIG. 4) via the interchange network 16 (shown in FIG. 4). The acquirer 14 forwards the MTI “0402” chargeback message along, where it is received by the merchant 12 for processing.

At operation 504, the CNPBS update module 28 reads the reason code. In the example embodiment, the MTI “0402” chargeback message received from the issuer 18 includes a chargeback reason code corresponding to “Cancelled Recurring Payment.” In other embodiments, the reason code may correspond to a different chargeback reason. At operation 506, if the reason code does not correspond to the “Cancelled Recurring Payment” reason code, the method 500 terminates at operation 512. In the exemplary embodiment, in response to the “Cancelled Recurring Payment” reason code, at operation 508, the CNPBS update module 28 extracts a PAN and issuer information from the MTI “0402” chargeback message. Specifically, the CNPBS update module 28 extracts a copy of the PAN from the MTI “0402” chargeback message and temporarily stores it in memory, such as memory 304 (shown in FIG. 3). In addition, the CNPBS update module 28 extracts a copy of the issuer identifying information from the MTI “0402” chargeback message and temporarily stores it in memory 304.

The CNPBS update module 28 verifies, at operation 510, that the issuer 18 identified by the issuer information is enrolled in the card-not-present account-on-file transaction blocking service (CNPBS) 26 and that the PAN is covered by a range of enrolled PANs by checking against the service, as indicated by arrow 511. If the issuer 18 is not enrolled, the method 500 terminates at operation 512. In an alternative embodiment, the interchange network 16 may require the cardholder to elect to participate in the card-not-present account-on-file transaction blocking service (CNPBS) service. In such an embodiment, the CNPBS update module 28 may verify that the cardholder 22 associated with the PAN is enrolled in the card-not-present account-on-file transaction blocking service (CNPBS) 26 and that the particular PAN is also enrolled by checking against the service. If the cardholder is not enrolled, the method 500 may terminate.

At operation 514, after verification that the issuer 18 is enrolled in the service (or in some embodiments, that the cardholder 22 is enrolled), the CNPBS update module 28 extracts necessary CNPBS information (i.e., blocking data) for generating an entry in the CNPBS database 26. For example, and without limitation, the CNPBS update module 28 extracts copies of the PAN, the acquirer's interbank card association (ICA) number, the merchant ID, and the transaction amount of the recurring payment. At operation 516, the CNPBS update module 28 generates a new CNPBS database entry or listing. At operation 518, the CNPBS returns the status of the new entry to the CNPBS update module 28 verifying that the entry is complete.

In the example method 500, at operation 520, the CNPBS update module 28 informs the issuer 18 that the CNPBS entry or listing was successfully completed. For example, and without limitation, the CNPBS update module 28 may send a status message to the issuer 18 or any other notification that enables the issuer 18 to be notified that the CNPBS database 26 is ready to block associated recurring transactions. The entry or listing may be configured to only block CNP transactions by the merchant for the associated PAN at the specified recurring payment amount. However, in some instances, the entry or listing may be configured to block all transactions by the merchant against the associated PAN. The above described method 500 facilitates reducing the number of chargebacks by the issuer 18 and facilitates reducing or eliminating the need to manually enter a merchant and cardholder account into the CNPBS database 26.

In the example embodiment, after the CNPBS database 26 has been updated with the new entry or listing, future authorization and clearing attempts on the PAN and from a given merchant 12 will be identified using the new entry and blocked. For example, and without limitation, in one scenario, the merchant 12 is a gym that processes monthly recurring transactions for an ongoing membership. The cardholder 22 may have cancelled his membership, but the gym may continue to process a monthly transaction against his account (e.g., the gym may have the cardholder's account on file). After the cardholder requests a chargeback from his issuer for an unauthorized payment, the gym's information is added to the CNPBS database 26. When the gym attempts to process a new transaction the following month, the gym's acquirer 14 would submit a payment authorization request message to the issuer 18 via the interchange network. The interchange network processes all CNP transactions against the CNPBS database 26, and because the gym has an entry, the payment would be declined. The interchange network 16 may submit a payment authorization response message to the acquirer 14 with a merchant advice code indicating that the transaction is declined because it is a “Blocked RPCS Transaction.”

Any actions, functions, operations, and the like recited herein may be performed in the order shown in the figures and/or described above, or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present invention.

A computer-readable storage media or medium comprising a non-transitory medium may include an executable computer program stored thereon and for instructing one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only, and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are example only, and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A transaction blocking system for updating a database for a card-not-present account-on-file transaction blocking service, said transaction blocking system comprising:
a memory device for storing data; and
a processor communicatively coupled to said memory device, said processor programmed to:
receive from an issuer a chargeback message including issuer identification information, a chargeback reason code, and a primary account number relating to a payment account of a cardholder;
read the chargeback reason code;
determine whether the chargeback message corresponds to a cancelled recurring payment; and
in response to determining that the chargeback message corresponds to a cancelled recurring payment, generate an entry within the database.

2. The transaction blocking system in accordance with claim 1,
said processor programmed to extract copies of the primary account number and the issuer identification information from the chargeback message and store the extracted data in the memory device.

3. The transaction blocking system in accordance with claim 2,
said processor programmed to:
verify that the issuer identified by the extracted issuer identification information is enrolled in the card-not-present account-on-file transaction blocking service; and
verify that the extracted primary account number is covered by a range of enrolled primary account numbers associated with the identified issuer.

4. The transaction blocking system in accordance with claim 1,
said processor programmed to extract blocking data from the chargeback message, wherein generating the entry within the database comprises generating the entry using the blocking data.

5. The transaction blocking system in accordance with claim 4,
said processor, in extracting the blocking data comprises, being further programmed to extract one or more of the following from the chargeback message: a copy of the primary account number, an acquirer's interbank card association number, a merchant ID, and a transaction amount.

6. The transaction blocking system in accordance with claim 1,
said processor programmed to receive from the card-not-present account-on-file transaction blocking service a status of the entry verifying that the entry is complete.

7. The transaction blocking system in accordance with claim 1,
said processor programmed to transmit to the issuer a notification that the entry is complete.

8. The transaction blocking system in accordance with claim 1,
said processor programmed to identify a subsequent transaction corresponding to the generated entry.

9. The transaction blocking system in accordance with claim 8,
said processor programmed to block the authorization and clearing of the identified subsequent transaction.

10. A computer-implemented method for updating a database for a card-not-present account-on-file transaction blocking service, said method comprising:
receiving, from an issuer, a chargeback message including issuer identification information, a chargeback reason code, and a primary account number relating to a payment account of a cardholder;
determining whether the chargeback message corresponds to a cancelled recurring payment;
in response to determining that the chargeback message corresponds to a cancelled recurring payment, extracting copies of the primary account number and the issuer identification information from the chargeback message;
storing the extracted primary account number and issuer identification information in the memory device; and
generating an entry within the database.

11. The method in accordance with claim 10, further comprising:
reading the chargeback reason code in the chargeback message.

12. The method in accordance with claim 10, further comprising:
verifying that the issuer identified by the extracted issuer identification information is enrolled in the card-not-present account-on-file transaction blocking service; and
verifying that the extracted primary account number is covered by a range of enrolled primary account numbers associated with the identified issuer.

13. The method in accordance with claim 10, further comprising:
extracting blocking data from the chargeback message, wherein generating the entry within the database comprises generating the entry using the blocking data.

14. The method in accordance with claim 13, wherein extracting the blocking data comprises extracting one or more of the following: a copy of the primary account number, an acquirer's interbank card association number, a merchant ID, and a transaction amount.

15. The method in accordance with claim 10, further comprising:
receiving, from the card-not-present account-on-file transaction blocking service, a status of the entry verifying that the entry is complete.

16. The method in accordance with claim 10, further comprising:
transmitting to the issuer a notification that the entry is complete.

17. One or more non-transitory computer-readable storage media having computer-executable instructions embodied thereon, wherein when executed by at least one processor, the computer-executable instructions cause the processor to:
receive from an issuer a chargeback message including issuer identification information, a chargeback reason code, and a primary account number relating to a payment account of a cardholder;
read the chargeback reason code;
determine whether the chargeback message corresponds to a cancelled recurring payment;
in response to determining that the chargeback message corresponds to a cancelled recurring payment, extract copies of the primary account number and the issuer identification information from the chargeback message;
store the extracted primary account number and issuer identification information in a memory device; and
generate an entry within a database for a card-not-present account-on-file transaction blocking service.

18. The computer-readable storage media in accordance with claim 17 wherein the computer-executable instructions further cause the processor to:
verify that the issuer identified by the extracted issuer identification information is enrolled in the card-not-present account-on-file transaction blocking service; and
verify that the extracted primary account number is covered by a range of enrolled primary account numbers associated with the identified issuer.

19. The computer-readable storage media in accordance with claim 17 wherein the computer-executable instructions further cause the processor to:
extract blocking data from the chargeback message, the blocking data including one or more of the following: a copy of the primary account number, an acquirer's interbank card association number, a merchant ID, and a transaction amount, and wherein generating the entry within the database comprises generating the entry using the blocking data.

20. The computer-readable storage media in accordance with claim 17 wherein the computer-executable instructions further cause the processor to:
receive, from the card-not-present account-on-file transaction blocking service, a status of the entry verifying that the entry is complete; and
transmit to the issuer a notification that the entry is complete.
